(19) United States
(12) Patent Application Publication
(10) Pub. No.: US 2002/0128920 A1
(43) Pub. Date: Sep. 12, 2002

(54) System and method for providing lowest costs purchasing

(76) Inventor: Dilip Chopra, Aurora, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/801,017

(22) Filed: Mar. 6, 2001

(51) Int. Cl. G06F 17/60

(52) U.S. Cl. 705/26

(57) ABSTRACT

A system and method for providing products and/or services to consumers from one or more sources or vendors is provided. The system comprises a computer system configured to receive an order (or inquiry) from a consumer for a plurality of products or services. The consumer can generate the order using a computing device. The computer system receives the order and electronically searches for prices for each of the products and/or services in the order. The computer system then groups the products and/or services into one or more groups and determines one or more sources or vendors that can provide the one or more groups at a lowest purchase cost after taking into account varied cost factors that may effect the final purchase cost of the order. The computer system then helps facilitate the purchase of the products and/or services from the one or more sources or vendors.

### BACKGROUND OF THE INVENTION

The present invention relates generally to systems and methods for facilitating lowest costs purchasing of products and/or services. More particularly, the present invention relates to systems and methods for identifying and/or presenting an optimized, final purchase cost savings to consumers or inquirers for a defined grouping of products and/or services, which could be purchased from multiple sources across any geopolitical, geographic, technological, and /or functional boundaries.

Given the advancement of technologies, more and more consumers are purchasing products or ordering services online via the Internet or some other electronic communication connection. When online shopping, the consumer typically uses sources or vendors with which the consumer is familiar or has an account. Unfortunately, the consumer does not know if the particular source or vendor with which he/she is shopping is providing products and/or services that represent the lowest purchase cost. In addition, browsing the large number of different sources or vendors online to find the best prices (or lowest purchase cost) for products or services can be extremely time consuming.

Certain price search engines already exist. However those search engines only are configured to find product prices from vendors for a single particular product, and do not take into consideration varied cost factors, such as: special discount arrangements that may exist between buyers and sellers; special time/volume based sales prices; promotions, coupons, rebates, or buyer/seller co-operative arrangements; shipping/delivery/set-up/testing costs; etc. Those search engines are not helpful for searching for the lowest purchase cost of a group of products and/or services. Using groceries as an example, while one particular grocery retailer may have a few products on sale or at cheaper prices than other retailers, other products provided by that retailer may not be cheaper. In fact, the total cost of all items needed (or inquired about) by the consumer from the grocery retailer may be more expensive than from other grocery retailers in a geographical area. The search engines currently known in the art do not provide consumers with price information regarding an entire order for products and/or services.

Thus, what is needed is a system and method for efficiently, conveniently, and economically determining a source or vendor that can provide a group of products and/or services at a lowest purchase cost. In addition, it would be advantageous that the system and method facilitate the purchase of the group of products and/or services from the lowest purchase cost source(s) or vendor(s).

### SUMMARY OF THE INVENTION

In accordance with an embodiment of the invention, a system and method for providing products and/or services to consumers from one or more sources or vendors is provided. The system comprises a computer system configured to receive an order from a consumer for a plurality of products or services. The consumer can generate the order using a computing device. The computer system receives the order and electronically searches for prices for each of the products and/or services in the order. The computer system then groups the products and/or services into one or more groups and determines one or more sources or vendors that can provide the one or more groups at a lowest purchase cost. The computer system then helps facilitate the purchase of the products and/or services from the one or more sources or vendors.

In accordance with one embodiment of the present invention, the computing device that the consumer uses to enter orders comprises ordering software loaded onto the computing device and configured to receive and transmit orders over a communication connection to the computer system.

In accordance with another embodiment of the present invention, the computing device that the consumer uses to enter orders receives an interactive application or applet from the computer system via a communication connection. The application or applet is configured to generate orders from the consumer and transmit the orders from the computing device to the computer system. The interactive application or applet may be created using Java, Java 2, HTML, XML or any other suitable programming language.

In accordance with one embodiment of the present invention, the communication connection connecting the computing device and the computer system may comprise any suitable communication connection known in the art, including, but not limited to, the Internet, a virtual private network, a dedicated private network, a wireless connection, a satellite connection, a direct dial phone connection, a local area network, a wide area network, or any other suitable connection currently know or hereinafter developed. In addition, the computing device may comprise any suitable computing device, such as a personal computer, a network workstation, a cellular phone, a satellite phone, an interactive television, a handheld computing device, a smart card device, etc.

In accordance with another embodiment of the present invention, the computer system searches for the lowest purchase cost for the plurality of products and/or services by electronically searching source or vendor databases electrically connected to the computer system, such as via the Internet or some other connection. In accordance with yet another embodiment of the present invention, the computer system can search for the lowest purchase cost by downloading price information from the vendors into a database associate with the computer system and searching that database. Any suitable search method can be used.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating one embodiment of a system embodying the present invention;

FIG. 2 is a flow chart illustrating a method for determining lowest cost provider(s) for a plurality of products; and

FIG. 3 is a flow chart illustrating more detailed aspects of the method illustrated in FIG. 2.

### DESCRIPTION OF THE SPECIFIC EMBODIMENTS

The present invention relates generally to systems and methods for facilitating lowest price purchases of products and/or services. More particularly, the present invention relates to systems and methods for receiving orders for products and/or services, searching source or vendor databases to locate the lowest prices for those products and/or services, and facilitating the purchase of products and/or services from the vendors having the lowest prices. In addition, a related single source product or service procurement system is disclosed in U.S. patent application Ser. No. 09/490,883, filed Jan. 24, 2000, the entirety of which is incorporated herein by reference for all purposes. The systems and methods of the present invention may be combined with or used in conjunction with the systems and methods disclosed in patent application Ser. No. 09/490,883.

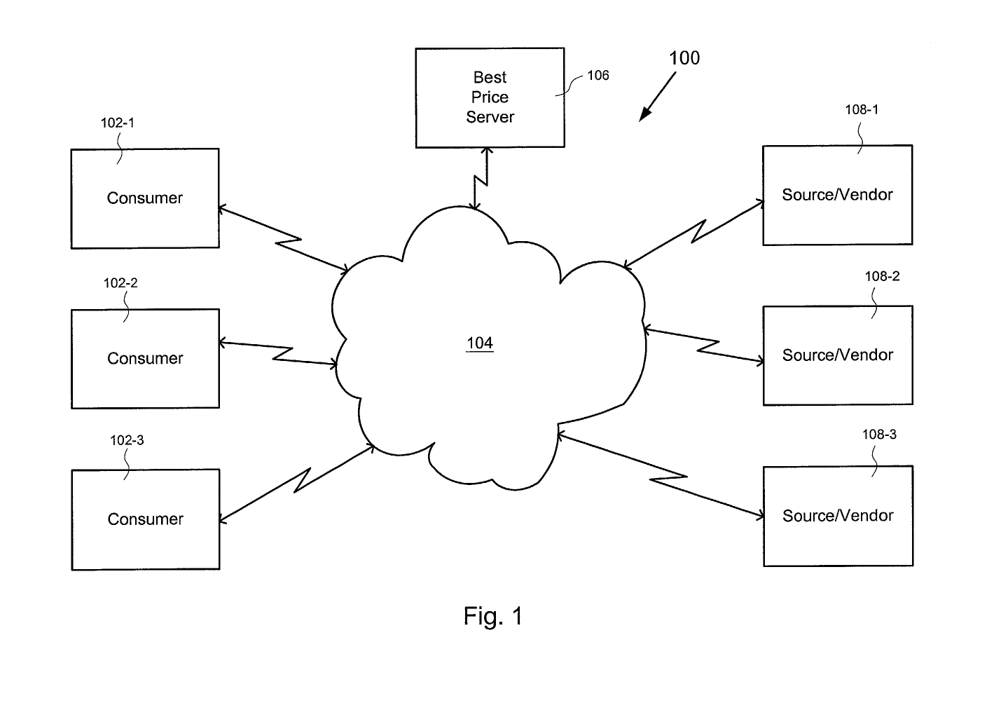

Referring now to FIG. 1, one embodiment of a system 100 for facilitating the lowest price purchase of products and/or services in shown. System 100 comprises a plurality of consumer computing devices 102 configured to communicate with a lowest purchase cost server 106 via a communication connection 104. In addition, system 100 further includes a plurality of product and/or service sources or vendors 108, which are configured to communicate with lowest purchase cost server 106 also via a communication connection 104. As discussed in more detail below, consumer computing devices 102 communicate orders or requests for products and/or services to lowest purchase cost server 106, which in turn searches sources 108 to locate one or more sources that can provide the products and/or services at a lowest cost.

As one skilled in the art will appreciate, communication connection 104 may comprise any suitable connection for facilitating communications between computing devices, including, but not limited to, the Internet, a virtual private network, a dedicated private network, a wireless connection, a satellite connection, a phone connection, a local area network, a wide area network, or the like. In addition, consumer computing devices 102 may comprise any suitable computing devices, such as personal computers, network workstations, cellular phones, satellite phones, interactive televisions, handheld computing devices, smart cards, or the like.

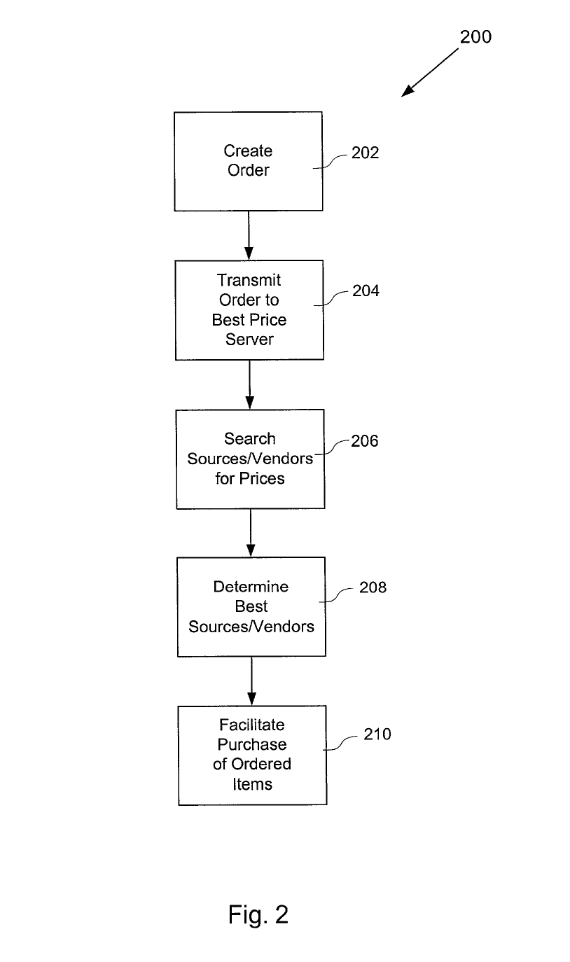

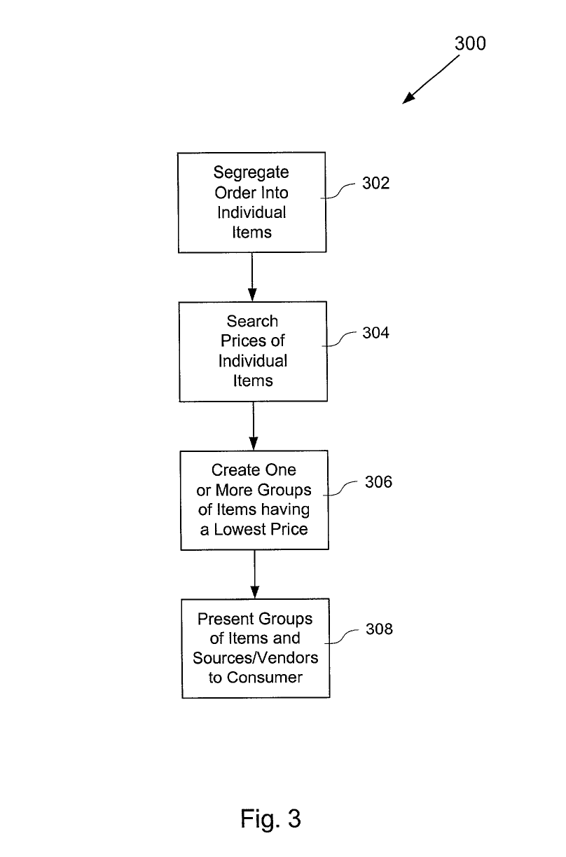

Referring now to FIGS. 2 and 3, flow charts 200 and 300 illustrate an embodiment of a method for determining a lowest cost source for a group of products and/or services. First, a consumer creates a request or order for a group of products and/or services using computing device 102 (step 202). The request can be for any product or service conceivable. For example, requests can be created for groceries or other household goods, hotel rooms, restaurants, products to be sold in retail shops, parts used in manufacturing facilities, or any other product or service.

To enter an order, computing device 102 may be loaded with software configured to generate order information from consumers, or an order entry application can be downloaded from lowest purchase cost server 106 to computing device 102 to facilitate the order entry process. If an application is downloaded from server 106, computing device 102 will include a browser or other suitable program for running the downloaded application. In addition, as one skilled in the art will appreciate, the downloadable order entry application can be created using any programming language suitable for creating interactive applications. Examples of such programming languages include, but are not limited to, Java, Java 2, HTML, XML, or the like.

Order information entered into the order entry software or downloaded application running on computing device 102 can include information such as, item type, item brand, price or price range information, a preferred source for the products and/or services desired, or any other order information that may be deemed relevant. Once the order information is entered, the order is transmitted from computing device 102 over communication connection 104 to lowest purchase cost server 106 (step 202). The transmitted order may take into account certain cost factors, including, but not limited to: special time and/or volume based sales prices; promotions, coupons, rebates, or buyer/seller co-operative arrangements; introduction/closeout price rate structures; or shipping/delivery/set-up/testing costs and/or estimates.

Lowest purchase cost server 106 is configured to receive product or service orders from computing devices 102 and search sources and/or vendors 108 to find the lowest costs for the products or services in the orders (step 206). In accordance with one embodiment of the present invention, lowest purchase cost server 106 is in electrical communication with sources or vendors 108, for example via communication connection 104. As mentioned above communication connection 104 can be any suitable communication connection. Each of the sources or vendors 108 may comprise one or more databases for holding product and price information. Thus, lowest purchase cost server 106 can gain access to the vendor databases and search those database for price information about the products or services set forth in the orders. Lowest purchase cost server 106 can use any suitable technology to search the vendor databases. For example, server 106 can send out database search queries to vendors' systems using XML or other suitable protocols. As one skilled in the art will appreciate, the type of vendor databases used will dictate the format of the query requests.

Referring now to FIG. 3, flow chart 300 illustrates the search methodology in more detail. In particular, lowest purchase cost server 106 receives an order and segregates the order into individual products and services (step 302). Lowest purchase cost server 106 then searches multiple sources or vendors 108 to obtain price information for each of the individual items (step 304). In accordance with this aspect of the present invention, each of the vendors 108 searched may offer all of the items listed in the order being searched, or alternatively, some vendors 108 may offer only a subset of items in the order.

After lowest purchase cost server 106 searches each of the vendor sites and obtains the appropriate product and price information, server 106 will divide the order into one or more “lowest cost” groups (step 306). For example, a health supplement retailer may be purchasing numerous health supplement products from one or more sources. Lowest purchase cost server 106 can determine which products are being offered by which sources at the lowest costs. Thus, if one source is offering some of the products in an order at a lowest price, and another source is offering the rest of the products in the order at a lowest price for those products, lowest purchase cost server 106 will divide the order into two groups to take advantage of the two separate lowest purchase cost sources. Alternatively, a consumer may only want to go to one source to buy all products listed in an order. In accordance with this aspect of the invention, lowest purchase cost server 106 will determine the total price for a complete order from multiple sources and compare those total prices to determine the lowest. Server 106 then will give the consumer the opportunity to purchase the order from the lowest price provider. As one skilled in the art will appreciate, products or services in an order can be grouped into any number of groups, depending on the number of separate sources providing lowest prices, and depending on the number of different sources a consumer wants to deal with.

After server 106 groups the items into the various groups, server 106 will present the groups of items to the consumer. In addition, server 106 will provide to the consumer one or more sources for the separate groups of items and the prices for each of the groups from each of the sources (step 308). Server 106 can present the product, price, grouping, and source information to the consumer by downloading an interactive application with the information, such as a web page or Java applet, to the consumer's computing device 102, or server 106 can communicate the information to order entry software, which as discussed above, may be residing on computing device 102.

Providing the product and price information to the consumer allows the consumer to choose preferred groupings and sources based on price or irrespective of price. For example, while it may be cheaper for a consumer to break an order into 3 groups and purchase items from 3 separate sources, a consumer may not wish to deal with that many separate sources. Thus, server 106 may give the consumer the option to purchase the 3 separate groups, 2 separate groups, or only a single group. Moreover, while one source may provide an order at a lower price than other sources, a consumer may wish to deal with a source with which he is more familiar. Thus, server 106 will give the consumer the option to choose a source even though it may be more expensive than other sources.

As one skilled in the art will appreciate, server 106 can provide to a consumer any number of different combinations of groups, prices and sources for an order of products and/or services. In fact, when a consumer places an order the ordering software or applications can be configured to solicit preference from the consumer. Thus, a consumer can specify grouping and source preferences (i.e., one group only, multiple groups, preferred sources, etc.)

In accordance with another embodiment of the present invention, in addition to providing merely price information to consumers, server 106 can be configured to obtain from sources or vendors 108 other product specials information, such as coupons, close out items, over-stocked items, etc. and provide that information to the consumers. In addition, server 106 can be configured to provide electronic coupons to consumers.

After server 106 presents the consumer with the grouping, price, and source options (step 208), the consumer then can order the products (step 210). Orders can be placed in a number of different ways. In accordance with one embodiment of the present invention, the consumer can use the product, price, grouping and source information provided to it to make purchasing decisions, and then order the products or services from the sources without the assistance of server 106.

Alternatively, the consumer can use lowest purchase cost server 106 and the associated software or application running on computing device 102 to place the orders. In accordance with this aspect of the present invention, the consumer, using computing device 102, can instruct lowest purchase cost server 106 to purchase the one or more groups of products from the one or more different sources. Serve 106 can store consumer and vendor ordering information, such as consumer name, billing address, delivery address, credit card number, customer credit account number, delivery instruction, or any other information that will help server 106 create orders with sources or vendors 108. Using some or all of this information, server 106 will place the orders and the sources or vendors will delivery the products directly to the consumer. If server 106 presents a source for products or service to a consumer with which the consumer has never dealt, and the consumer wants to order from that source or vendor, server 106 can be configured to facilitate the opening of an account with that source for the consumer. In accordance with this aspect of the invention, server 106 can be configured to apply for credit checks, submit customer applications or anything else that may be needed to facilitate the setting-up of a consumer as a customer of a vendor.

In accordance with yet another embodiment of the present invention, instead of submitting the order for products or service to the vendor, server 106 can be configured to connect the consumer's computing device 102 directly with the vendors 108, so that the consumer can place the orders directly with the vendors. HTML links or other suitable connection means can be used to connect the consumer's computing devices with the vendors.

In accordance with yet another embodiment of the present invention, the systems and methods of the present invention can be configured with or used by any inventory control and order processing systems known in the art. As one skilled in the art will appreciate, many wholesale and retail stores, manufacturing facilities, and service providers implement inventory control and order processing systems. For example, a retail store may use bar code scanners or other equipment to facilitate purchase and track the inventory of products in the store. By scanning products on the shelf and/or tracking products as they are purchased, the inventory control systems will know when product inventory is getting low. Some product inventory systems can be configured to automatically generate orders for products when inventories get low. In accordance with one embodiment of the present invention, such inventory control systems can be configured to communicate with server 106 in order to locate vendor(s) offering the products being ordered at a lowest price. Moreover, as one skilled in the art will appreciate, “inventory control systems” for the home also can be used with the systems and methods of the present invention. For example, scanning systems and computing devices used in the home to create shopping lists or the like can be configured to generate orders and communicate with server 106 to locate lowest price providers.

In conclusion, the present invention provides novel systems and methods for facilitating lowest price purchases of one or more products and/or services. While detailed descriptions of one or more embodiments of the invention have been given above, various alternatives, modifications, and equivalents will be apparent to those skilled in the art. For example, while the present invention is illustrated and disclosed herein as communicating over the Internet, one skilled in the art will appreciate that any communication connection may be used without varying from the spirit of the invention. Therefore, the above description should not be taken as limiting the scope of the invention, which is defined by the appended claims.

What is claimed is:

1. A method for providing products or services to consumers from one or more sources, comprising the steps of:
receiving at a computer system an order from a consumer for a plurality of products or services, the order being generated by a computing device;
electronically searching sources for prices of the plurality of products or services;
grouping the plurality of products or services into one or more groups of products or services;
determining one or more sources that can provide the one or more groups of products or services at a lowest cost; and
facilitating the purchase by the consumer of the one or more groups of products or services from the one or more sources.

2. The method as recited in claim 1 wherein in the grouping step, each of the one or more groups of products or services may comprise one or more products or services.

3. The method as recited in claim 1 wherein the receiving step further comprises the step of:
providing the consumer with software to be loaded on the computing device, the software being configured to receive orders from the consumer and communicate the orders to the computer system via a communication connection; and
after the consumer enters the order for the plurality of products or services, the computer system receiving the order from the computing device.

4. The method as recited in claim 3 wherein the communication connection is a communication connection selected from the group comprising the Internet, a virtual private network, a dedicated private network, a wireless connection, a satellite connection, a phone connection, a local area network, or a wide area network.

5. The method as recited in claim 1 wherein the receiving step further comprises the steps of:
the computer system sending an interactive application to the computing device via a communication connection, the interactive application being configured to receive orders for products or services from the consumer; and
after the consumer enters the order for the plurality of products or services, the computer system receiving the order from the computing device.

6. The method as recited in claim 5 wherein the communication connection is a communication connection selected from the group comprising the Internet, a virtual private network, a dedicated private network, a wireless connection, a satellite connection, a phone connection, a local area network, or a wide area network.

7. The method as recited in claim 5 wherein the interactive application may comprise a web page created using Java, Java 2, HTML, or XML languages.

8. The method as recited in claim 1 wherein the computing device may be a computing device from the group comprising a personal computer, a network workstation, a cellular phone, a satellite phone, an interactive television, a handheld computing device, or a smart card device.

9. The method as recited in claim 1 wherein the electronically searching step comprises the computer system searching a source's database electronically connected to the computer system for the prices.

10. The method as recited in claim 1 wherein the electronically searching step further comprises the steps of:
downloading the prices for the products or services from the sources into a database associated with the computer system; and
electronically searching the database associated with the computer system.

11. The method as recited in claim 1 wherein the determining step comprise the step of determining a single source that can provide the one or more groups of products or services at a lowest cost.

12. The method as recited in claim 1 wherein the facilitating step comprises the step of the computer system placing an order with the one or more sources for the one or more products or services ordered by the consumer.

13. The method as recited in claim 1 wherein the facilitating step comprises the step of connecting the consumer's computing device with the one or more sources so that the consumer can place the order with the one or more sources.

14. The method as recited in claim 1 wherein the determining step further comprises the step of considering one or more additional cost factors other than price, the additional cost factors being selected from the group, including: special discount arrangements between buyers and sellers; special time or volume based sales prices; promotions, coupons, rebates, or buyer/seller co-operative arrangements; product introduction or closeout price rate structures; or shipping, delivery, set-up, or testing costs or estimates.

15. A method for obtaining products or services from one or more sources, comprising the steps of:
a consumer entering an order for one or more products or services into a computing device;
transmitting the order via a communication connection from the computing device to a computer system comprising a lowest cost search engine;
electronically searching sources for prices of the plurality of products or services;
grouping the plurality of products or services into one or more groups of products or services;
determining one or more sources that can provide the one or more groups of products or services at a lowest cost; and
facilitating the purchase by the consumer of the one or more groups of products or services from the one or more sources.

16. The method as recited in claim 15 wherein the entering an order step comprises the steps of:
scanning the bar code of a desired product or service; and
creating an order for the scanned desired product or service.

17. The method as recited in claim 15 wherein in the grouping step, each of the one or more groups of products or services may comprise one or more products or services.

18. The method as recited in claim 15 wherein the receiving step further comprises the step of:
providing the consumer with software to be loaded on the computing device, the software being configured to receive orders from the consumer and communicate the orders to the computer system via a communication connection; and
after the consumer enters the order for the plurality of products or services, the computer system receiving the order from the computing device.

19. The method as recited in claim 18 wherein the communication connection is a communication connection selected from the group comprising the Internet, a virtual private network, a dedicated private network, a wireless connection, a satellite connection, a phone connection, a local area network, or a wide area network.

20. The method as recited in claim 15 wherein the receiving step further comprises the steps of:
the computer system sending an interactive application to the computing device via a communication connection, the interactive application being configured to receive orders for products or services from the consumer; and
after the consumer enters the order for the plurality of products or services, the computer system receiving the order from the computing device.

21. The method as recited in claim 20 wherein the communication connection is a communication connection selected from the group comprising the Internet, a virtual private network, a dedicated private network, a wireless connection, a satellite connection, a phone connection, a local area network, or a wide area network.

22. The method as recited in claim 20 wherein the interactive application may comprise a web page created using Java, Java 2, HTML, or XML languages.

23. The method as recited in claim 15 wherein the computing device may be a computing device from the group comprising a personal computer, a network workstation, a cellular phone, a satellite phone, an interactive television, a handheld computing device, or a smart card device.

24. The method as recited in claim 15 wherein the electronically searching step comprises the computer system searching a source's database electronically connected to the computer system for the prices.

25. The method as recited in claim 15 wherein the electronically searching step further comprises the steps of:
downloading the prices for the products or services from the sources into a database associated with the computer system; and
electronically searching the database associated with the computer system.

26. The method as recited in claim 15 wherein the determining step comprise the step of determining a single source that can provide the one or more groups of products or services at a lowest cost.

27. The method as recited in claim 15 wherein the facilitating step comprises the step of the computer system placing an order with the one or more sources for the one or more products or services ordered by the consumer.

28. The method as recited in claim 15 wherein the facilitating step comprises the step of connecting the consumer's computing device with the one or more sources so that the consumer can place the order with the one or more sources.

29. The method as recited in claim 15 wherein the determining step further comprises the step of considering one or more additional cost factors other than price, the additional cost factors being selected from the group, including: special discount arrangements between buyers and sellers; special time or volume based sales prices; promotions, coupons, rebates, or buyer/seller co-operative arrangements; product introduction or closeout price rate structures; or shipping, delivery, set-up, or testing costs or estimates.

30. A system for providing products or services to consumers from one or more sources, comprising:
a computer system configured to receive an order from a consumer for a plurality of products or services, the order being generated by a computing device, the computer system being configured to;
electronically search sources for prices of the one or more groups of products or services;
group the products or services into one or more groups of products or services;
determine one or more sources that can provide the one or more groups of products or services at a lowest cost; and
facilitate the purchase by the consumer of the one or more groups of products or services from the one or more sources.

31. The system as recited in claim 30 wherein the one or more groups of products or services may comprise one or more products or services.

32. The system as recited in claim 30 wherein the computing device comprises software configured to receive orders from the consumer and communicate the orders to the computer system via a communication connection.

33. The system as recited in claim 32 wherein the communication connection is a communication connection selected from the group comprising the Internet, a virtual private network, a dedicated private network, a wireless connection, a satellite connection, a phone connection, a local area network, or a wide area network.

34. The system as recited in claim 30 wherein the computer system is configured to send an interactive application to the computing device via a communication connection, the interactive application being configured to receive orders for products or services from the consumer and communicate the orders to the computer system.

35. The system as recited in claim 34 wherein the communication connection is a communication connection selected from the group comprising the Internet, a virtual private network, a dedicated private network, a wireless connection, a satellite connection, a phone connection, a local area network, or a wide area network.

36. The system as recited in claim 34 wherein the interactive application comprises a web page created using Java, Java 2, HTML, or XML.

37. The system as recited in claim 30 wherein the computing device is a computing device from the group comprising a personal computer, a network workstation, a cellular phone, a satellite phone, an interactive television, a handheld computing device, or a smart card device.

38. The system as recited in claim 30 wherein the computer system is configured to search a source's database for the product or service prices.

39. The system as recited in claim 30 wherein the computer system is configured to download the prices for the products or services from the sources into a database associated with the computer system and electronically search the database associated with the computer system.

40. The system as recited in claim 30 wherein the computer system is configured to determine a single source that can provide the one or more groups of products or services at a lowest cost.

41. The system as recited in claim 30 wherein the computer system is configured to place an order with the one or more sources for the one or more products or services ordered by the consumer.

42. The system as recited in claim 30 wherein the computer system is configured to connect the consumer's computing device with the one or more sources so that the consumer can place the order with the one or more sources.

43. The system as recited in claim 30 wherein the computer system considers one or more additional cost factors other than price to determine the lowest cost, the additional cost factors being selected from the group, including: special discount arrangements between buyers and sellers; special time or volume based sales prices; promotions, coupons, rebates, or buyer/seller co-operative arrangements; product introduction or closeout price rate structures; or shipping, delivery, set-up, or testing costs or estimates.

44. The system as recited in claim 30 the computing device further comprises:
a bar code scanner for scanning the bar code of a desired product or service; and
software for creating an order for the scanned desired product or service.
